(19) United States
(12) Patent Application Publication
(10) Pub. No.: US 2014/0065276 A1
(43) Pub. Date: Mar. 6, 2014

(54) MUDDLER AID DEVICES AND RELATED METHODS

(71) Applicant: Calibi Custom, LLC, Auburn, WA (US)

(72) Inventor: Jesse Howard, Auburn, WA (US)

(21) Appl. No.: 13/966,138

(22) Filed: Aug. 13, 2013

Related U.S. Application Data
(60) Provisional application No. 61/697,645, filed on Sep. 6, 2012.

(51) Int. Cl. A47J 43/27

(52) U.S. Cl. CPC A47J 43/27
USPC 426/489; 210/474; 99/275

(57) ABSTRACT

A muddler aid device is provided for muddling ingredients in an open-ended receptacle. The muddler aid device includes a body in the form of a generally planar disc to cover at least a majority of a mouth of the open-ended receptacle and a sidewall that extends from a periphery of the body to surround at least a substantial portion of a perimeter of the mouth of the open-ended receptacle. The device further includes a muddler access port positioned at or near the periphery of the body which is sized to receive a muddler therethrough. A plurality of discharge apertures are arranged proximate the periphery of the body to strain contents of the open-ended receptacle after muddling thereof. A grip feature may also be formed in the body to assist in discharging strained contents from the open-ended receptacle. Related methods of muddling contents are also provided.

### BACKGROUND

1. Technical Field

The present disclosure is directed to beverage preparation devices, and more particularly, to devices for assisting in the muddling and straining of muddled contents for cocktails and other beverages.

2. Description of the Related Art

Conventional devices for muddling contents for beverages, such as cocktails, include a muddler that is used like a pestle to mash or muddle fruits, herbs, spices and other ingredients in the bottom of a glass or other receptacle to release their flavor. An example of a conventional muddler 10 and receptacle 12 is shown in FIG. 1. Conventional devices for straining contents for beverages, such as cocktails, include a separate strainer device that is positionable within a mouth of a glass or other receptacle to strain the contents thereof when poured through the strainer device. An example of a conventional cocktail strainer 16 in the form of a Hawthorne type strainer is shown in FIG. 2 with the strainer 16 positioned within the mouth of a receptacle 14, which is in the form of a cocktail shaker. The strainer 16 may be used to separate ice, pulp, and other matter from the liquid contents of the receptacle 14.

When it is desired to both muddle and strain contents for a cocktail or other beverage, one typically utilizes separate muddler and strainer devices in a sequential manner. This can be cumbersome and inefficient, especially when preparing many beverages as is typical for a bartender.

### BRIEF SUMMARY

The muddler aid devices and related methods described herein provide for muddling and straining contents for cocktails and other beverages in a particularly convenient and efficient form factor. Embodiments of the muddler aid devices are particularly well suited for use by bartenders.

According to one embodiment, a muddler aid device for muddling ingredients in an open-ended receptacle may be summarized as including: a body in the form of a generally planar disc to cover at least a majority of a mouth of the open-ended receptacle; a sidewall that extends from a periphery of the body to surround at least a substantial portion of a perimeter of the mouth of the open-ended receptacle; a muddler access port positioned at or near the periphery of the body which is sized to receive a muddler therethrough; and a plurality of discharge apertures arranged proximate the periphery of the body to strain contents of the open-ended receptacle when poured therethrough. The muddler aid device may further include a grip feature formed in the body to assist in discharging strained contents from the open-ended receptacle.

According to another embodiment, a method of muddling may be summarized as including: positioning a muddler aid device over an open-ended receptacle, the muddler aid device including a body in the form of a generally planar disc to cover at least a majority of a mouth of the open-ended receptacle, a muddler access port, a plurality of discharge apertures and a grip feature; muddling contents of the open-ended receptacle with a muddler received through the muddler access port; and straining the muddled contents through the plurality of discharge apertures while engaging the grip feature.

### BRIEF DESCRIPTION OF THE SEVERAL VIEWS OF THE DRAWINGS

FIG. 1 is an isometric view of a conventional muddler received in a glass receptacle.

FIG. 2 is an isometric view of a conventional strainer positioned within the mouth of a cocktail shaker.

FIG. 3 is an isometric view of a muddler aid device, according to one embodiment, shown positioned on a glass receptacle with a muddler received therethrough.

FIG. 4 is an image of a muddler aid device, according to one embodiment, shown positioned for use upon a glass receptacle with muddled contents and ice therein.

FIG. 5 is an image of the muddler aid device of FIG. 4 shown in an orientation for discharging muddled contents into a cocktail glass.

FIG. 6 is an isometric view of the muddler aid device of FIG. 3 showing a top side thereof.

FIG. 7 is an isometric view of the muddler aid device of FIG. 3 showing a bottom side thereof.

FIG. 8 is an isometric view of a muddler aid device, according to another embodiment, showing a bottom side thereof.

FIG. 9 is an isometric view of a muddler aid device, according to yet another embodiment, showing a top side thereof.

FIG. 10 is an isometric view of a muddler aid device, according to yet another embodiment, showing a top side thereof.

FIG. 11 is an isometric view of a muddler aid device, according to yet another embodiment, showing a top side thereof.

FIG. 12 is an isometric view of a muddler aid device, according to yet another embodiment, showing a top side thereof.

FIG. 13 is an isometric view of a muddler aid device, according to still yet another embodiment, shown positioned for use on a glass receptacle with a muddler received therethrough.

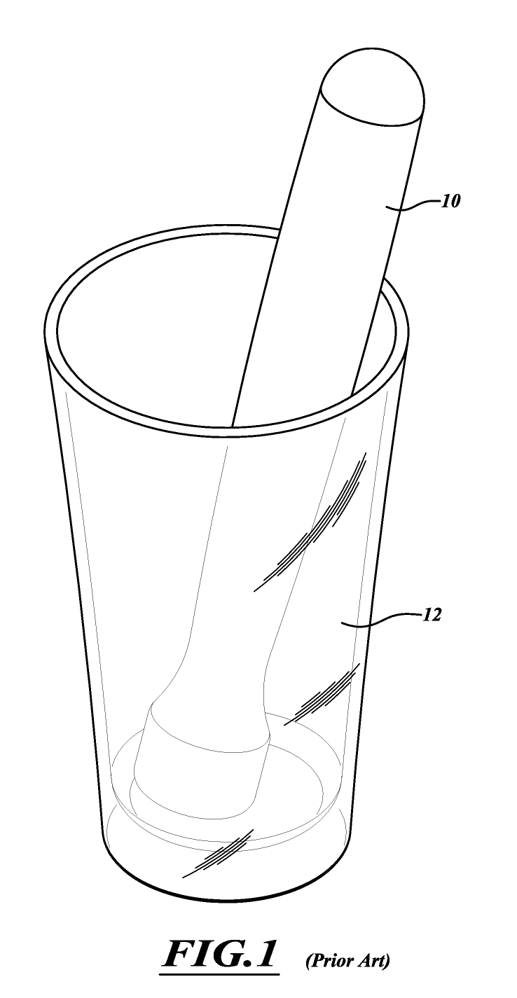

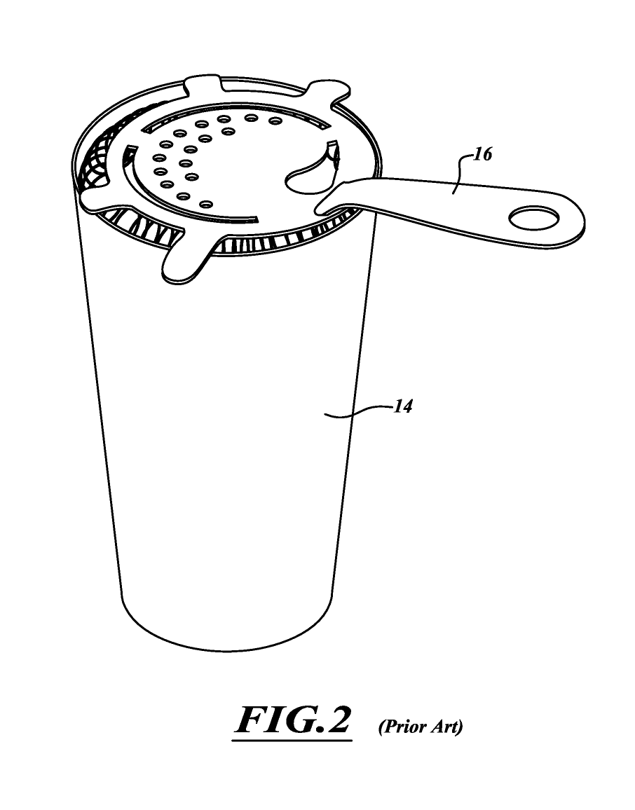

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures associated with barware and other devices for preparing cocktails and other beverages may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

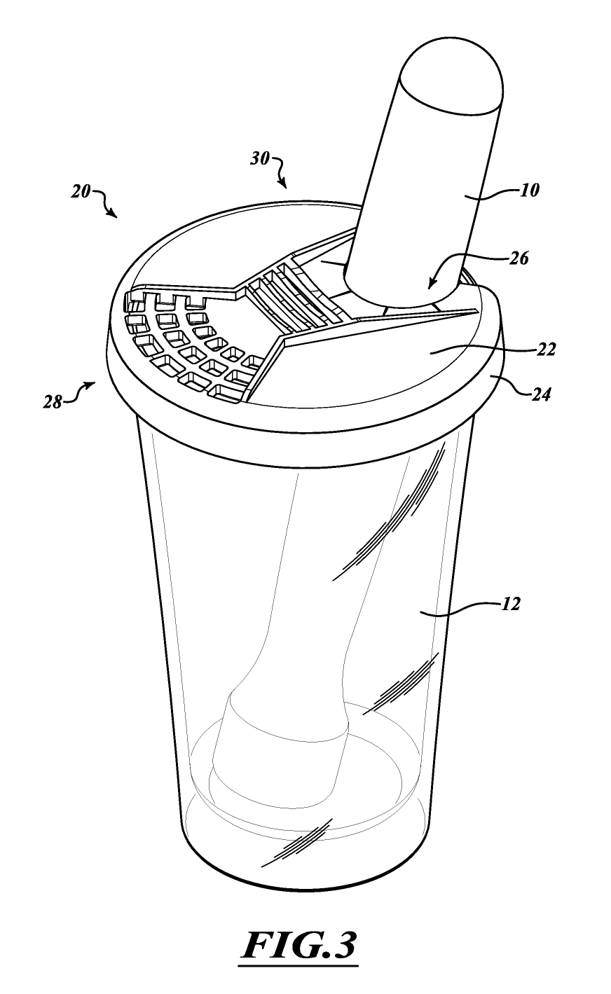

FIG. 3 shows a muddler aid device 20, according to one example embodiment. The muddler aid device 20 is positioned on a conventional glass receptacle 12 with a muddler 10 received therethrough. It is to be understood that the muddler aid device 20 can be used on containers and receptacles made of materials other than glass, including without limitation plastic and plastic-like material, ceramic, and wood. The receptacle generally includes a bottom, a sidewall attached to the bottom and circumscribing an interior, and an open top or mouth in communication with the interior.

The muddler aid device 20 includes a body 22 in the form of a generally planar disc sized and shaped to cover at least a majority of a mouth of the open-ended receptacle 12 when the muddler aid device 20 is positioned over the mouth. The muddler aid device 20 further includes a sidewall 24 that extends or projects from a periphery of the body 22 to surround at least a substantial portion of a perimeter of the mouth of the open-ended receptacle 12 when the muddler aid device 20 is positioned for use. In this manner, the body 22 and sidewall 24 define a cap or cover that may be placed over the open-end of the receptacle 12 to at least partially close or seal the mouth of the receptacle 12. Advantageously, the muddler aid device 20 can minimize or substantially prevent splash back during muddling activities.

The muddler aid device 20 further includes a muddler access port 26 configured to enable a working end 27 of the muddler 10 to be received within the interior of the receptacle 12 with a handle end 29 of the muddler 10 protruding from the open-end or mouth of the receptacle 12. The muddler access port 26 may be positioned at or near the periphery of the body 22 and sized to receive the muddler 10 therethrough. In some embodiments, the muddler access port 26 is sized to closely conform to the handle portion of the muddler 10 such that splash back from the interior of the receptacle 12 is minimized during muddling activities.

The muddler aid device 20 further includes a strainer arrangement 28 to strain contents of the open-ended receptacle 12 after muddling. The strainer arrangement 28 may include a plurality of discharge apertures arranged proximate the periphery of the body 22 within another region of the body 22. The strainer arrangement 28 may be positioned opposite the muddler access port 26.

The muddler aid device 20 may further include a grip feature 30 formed in the body 22 to assist in discharging strained contents from the open-ended receptacle 12. For example, a user may engage the grip feature 30 with his or her finger when tilting the receptacle 12 and discharging contents therefrom. The grip feature 30 may be centrally located and may include a series of ribs 60 (FIG. 6) or protrusions. In some embodiments, the grip feature 30 may define a concave surface 62 (FIG. 6) that is sized and shaped to receive a finger of a user, for example, when discharging contents from the open-ended receptacle 12.

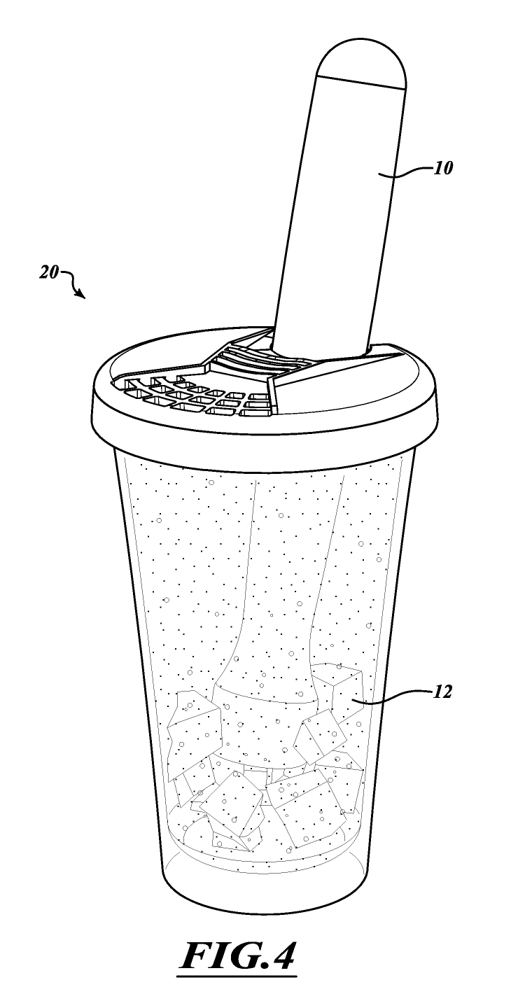

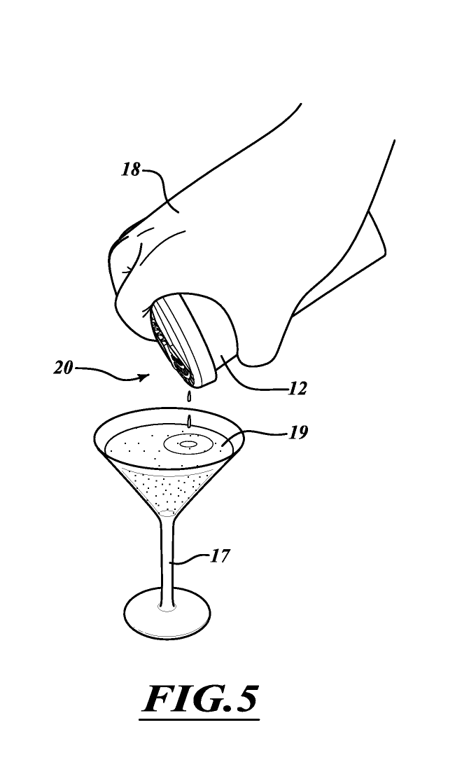

FIGS. 4 and 5 illustrate use of the muddler assist device 20 to prepare a cocktail. In particular, FIG. 4 shows a muddler 10 extending through the muddler aid device 20 into the receptacle 12. The device 20 is configured to enable a user to muddle the contents thereof with the muddler aid device 20 acting as a barrier between the contents of the receptacle 12 and the external environment. Advantageously, the muddler aid device 20 can assist in guiding and controlling the muddler 10 during muddling operations and simultaneously reduce or substantially prevent splash back. The muddler 10 may then be withdrawn from the receptacle without removing the muddler aid device 20 and the receptacle 12 tilted or reoriented by a user 18 to discharge muddled and strained contents 19 into a cocktail glass 17 or other desired vessel for subsequent consumption, as shown in FIG. 5. As previously discussed, the user 18 may advantageously engage a grip feature 30 formed in or otherwise provided on the muddler aid device 20. In view of the above, activities of muddling and straining contents for a cocktail or other beverage may be streamlined. In addition, the muddler aid device 20 improves sanitation by reducing or substantially eliminating the occurrence of splash back and spills otherwise associated with conventional muddling and straining activities.

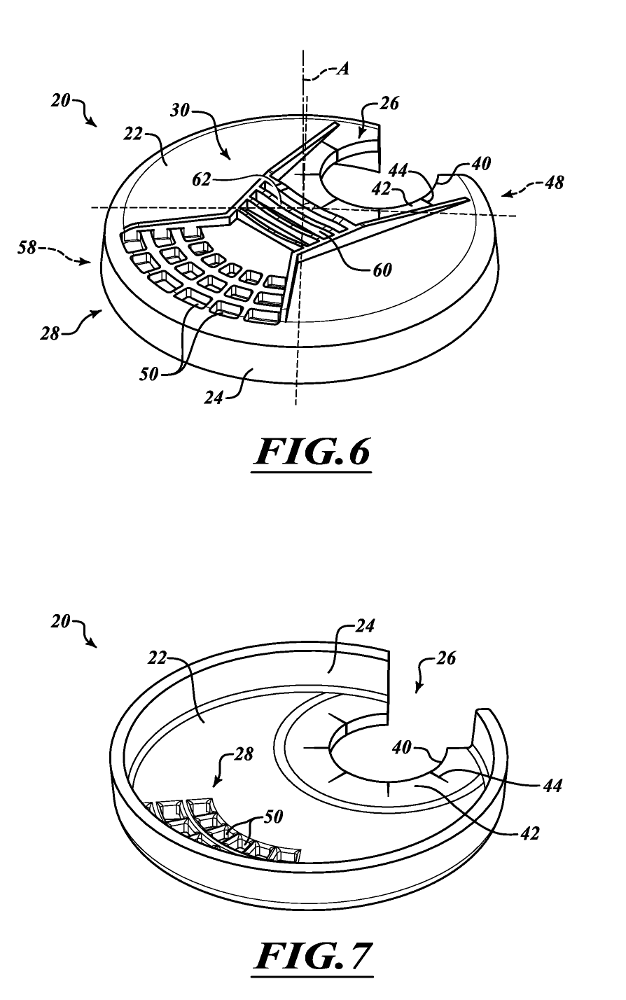

Further details of the muddler aid device 20 will now be described with reference to FIGS. 6 and 7. As shown in FIGS. 6 and 7, the muddler aid device 20 may be formed as a unitary or integral device including the body 22, sidewalls 24, muddler access port 26, strainer arrangement 28 and grip feature 30. In other embodiments, the muddler aid device 20 may include one or more separate components or layers coupled or formed together. For example, in some embodiments, the grip feature 30 may be removably coupled to the muddler aid device 20. The muddler aid device 20 may be formed of a substantially rigid or semi-rigid material and may be sized to loosely or closely mate with the mouth of the open-ended receptacle 12. In other embodiments, the muddler aid device 20 may be formed of a flexible material which can elastically deform to sealingly engage the perimeter of the mouth of the open-ended receptacle 12.

As shown in FIGS. 6 and 7, the muddler access port 26 of the muddler aid device 20 may define a generally circular aperture 40 surrounded by a flexible skirt 42 formed by intermediate slits 44. In this manner, the aperture 40 can adjust for possible variations in the cross-sectional profile of the muddler 10 over a length thereof as the muddler 10 is moved up and down during muddling activities. In addition, the flexible nature of the muddler access port 26 may facilitate insertion and removal of the muddler 10 without removing the muddler aid device 20 from the receptacle 12. This may be true even when the muddler 10 includes an enlarged working end relative to the handle end. The muddler access port 26 may interrupt the periphery of the muddler aid device 20, as shown in FIGS. 6 and 7, or may be formed internally relative to the peripheral edge of the device 20.

According to the example embodiment shown in FIGS. 6 and 7, the muddler access port 26 is located within a first quadrant 48 of the muddler aid device 20 and the strainer arrangement 28 is located in another quadrant 58 of the muddler aid device 20 opposite the first quadrant 48. The strainer arrangement 28 and the muddler access port 26 may be symmetric about a same plane of symmetry. The strainer arrangement 28 may include a plurality of discharge apertures 50 near the peripheral edge of the muddler aid device 20. The plurality of discharge apertures 50 may be arranged to define a sieve or grate-like region of the muddler aid device 20, as shown in FIGS. 6 and 7. The plurality of discharge apertures 50 may be sized to allow fluid to pass therethrough while restricting moderate to large sized ice particles and other matter, such as, for example, pulp and rinds.

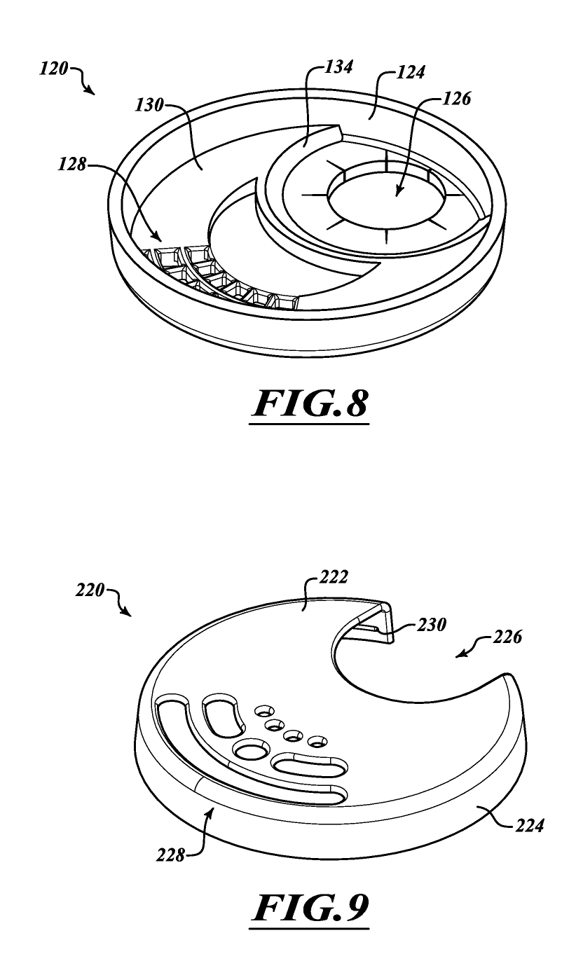

FIG. 8 shows another embodiment of a muddler aid device 120 similar to that of FIGS. 6 and 7, but wherein a muddler access port 126 is located internally with respect to a sidewall 124 of the device 120. In addition, a upstanding wall 134 is provided around at least a portion of the muddler access port 126 to provide a partial barrier between the muddler access port 126 and a strainer arrangement 128 positioned opposite thereto. Still further, the muddler aid device 120 includes an inclined or sloped surface 130 to direct muddled contents toward the strainer arrangement 128 during straining activities. Moreover, a channel 136 may be formed or otherwise provided on the underside of the muddler aid device 120 to route muddled contents toward the strainer arrangement 128 when discharging such contents through the device 120.

FIG. 9 shows yet another embodiment of a muddler aid device 220 including a body 222 in the form of a generally planar disc and a sidewall 224 extending from a peripheral edge thereof. A muddler access port 226 is formed in the body 222 and interrupts the sidewall 224 from extending entirely around the device 220. The muddler access port 226 may be sized such that the device can be installed and removed from a receptacle 12 with a muddler 10 received therein. A seal device 230, such as, for example, an o-ring or gasket, may be formed or otherwise provided on an inner surface of the sidewall 224 to assist in maintaining the muddler aid device 220 engaged with the receptacle 12 during use, and in some instances sealingly engaged. As can be appreciated from FIG. 9, the discharge apertures of the strainer arrangement 228 may take a variety of forms and arrangements, including, for example, an arrangement of arcuate slots and circular apertures spaced at increasing radial distances from a central axis of the device 220.

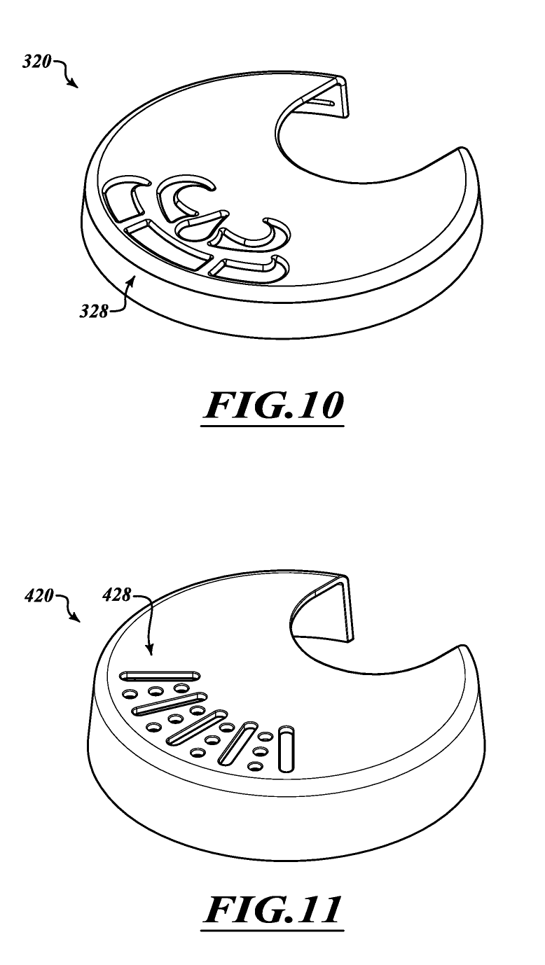

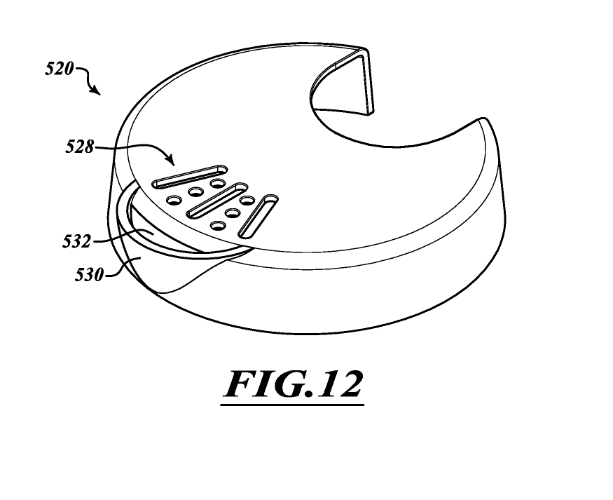

FIGS. 10 through 12 further illustrate the variety of strainer arrangements 328, 428, 528 that may be included in the various muddler aid devices 328, 428, 528 shown therein. In addition, FIG. 12 shows an example embodiment of a muddler aid device 520 that includes a spout 530 with discharge aperture 532 proximate the strainer arrangement 528 to assist in discharging muddled contents. In some embodiments, the strainer arrangement 528 may form the discharge aperture 532 of the spout 530.

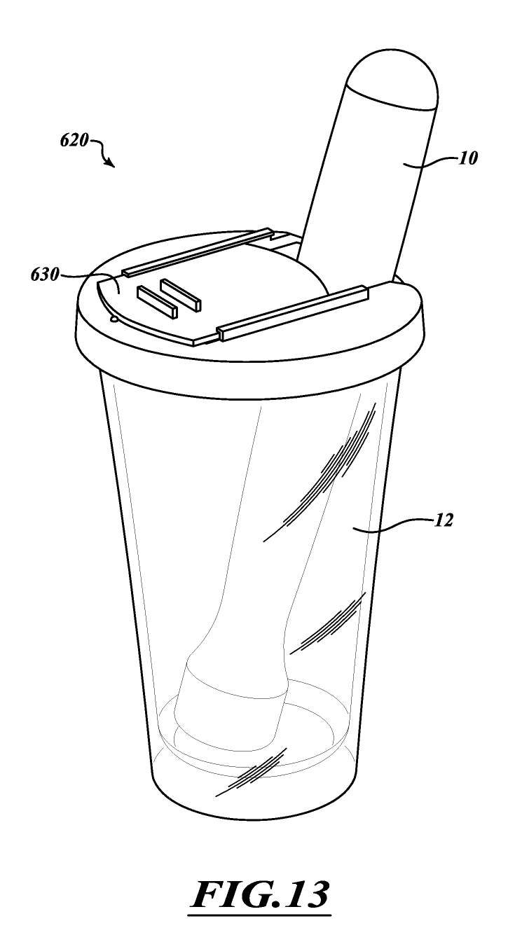

FIG. 13 shows still yet another example embodiment of a muddler aid device 620 coupled to a receptacle 12 and receiving a muddler 10 therethrough. In this embodiment, the muddler aid device 620 is provided with a cover element 630 which may selectively cover or conceal a strainer arrangement (not visible) of the device 620. In this manner, the strainer arrangement may be substantially or entirely covered during muddling activities to further reduce splash back that might otherwise occur. Still further, the cover element may be movably coupled to the body 622 of the muddler aid device 620 to selectively cover or conceal at least a portion of the muddler access port 626 and/or reveal the strainer arrangement during straining activities. The cover element 630 may also include or otherwise act as a grip feature for assisting in orienting the receptacle 12 and discharging muddled contents.

In accordance with the various muddler aid devices described herein, a related method may be provided which includes positioning a muddler aid device over an open-ended receptacle; muddling contents of the open-ended receptacle with a muddler received through a muddler access port of the muddler aid device; and straining the muddled contents through a plurality of discharge apertures of the muddler aid device while engaging a grip feature thereof. As such, a user, such as, for example, a bartender, can readily prepare muddled cocktails in a particularly efficient manner while improving sanitation.

While the muddler aid devices described herein may be produced and marketed as a standalone product, it is appreciated that in some instances, the muddler aid devices may be packaged as a kit with a muddler and an open-ended receptacle, such as, for example a pint glass. Such kits may also include other cocktail preparation tools or barware and/or a bottle of alcohol packaged therewith in a gift pack, for example.

Moreover, aspects and features of the various embodiments described above can be combined to provide further embodiments. In addition, U.S. Provisional Application No. 61/697,645, filed Sep. 6, 2012, is incorporated herein by reference for all purposes and aspects of the invention can be modified, if necessary, to employ features, systems, and concepts disclosed in these applications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A muddler aid device for muddling ingredients in an open-ended receptacle, the muddler aid device comprising:
a body in the form of a generally planar disc to cover at least a majority of a mouth of the open-ended receptacle when the muddler aid device is positioned over the mouth of the open-ended receptacle;
a sidewall that extends from a periphery of the body to surround at least a substantial portion of a perimeter of the mouth of the open-ended receptacle when the muddler aid device is positioned over the mouth of the open-ended receptacle;
a muddler access port positioned at or near the periphery of the body within a first quadrant of the body and sized to receive a muddler therethrough;
a plurality of discharge apertures arranged proximate the periphery of the body within a second quadrant of the body to strain contents of the open-ended receptacle with the muddler aid device positioned over the mouth thereof; and
a grip feature formed in the body to assist in discharging strained contents from the open-ended receptacle.

2. The muddler aid device of claim 1 wherein the body, the sidewall, the muddler access port, the plurality of discharge apertures and the grip feature are formed as an integral muddler aid.

3. The muddler aid device of claim 2 wherein the integral muddler aid is formed of a substantially rigid or semi-rigid material.

4. The muddler aid device of claim 2 wherein the integral muddler aid is formed of a flexible material which may elastically deform to sealingly engage the perimeter of the mouth of the open-ended receptacle.

5. The muddler aid device of claim 1, further comprising:
a seal coupleable to the sidewall to sealingly engage the perimeter of the mouth of the open-ended receptacle during use.

6. The muddler aid device of claim 1, further comprising:
a flexible skirt around the periphery of the muddler access port.

7. The muddler aid device of claim 6 wherein the muddler access port is sized to closely receive a shaft of the muddler when the muddler is received for use and wherein the flexible skirt enables the muddler access port to flex to receive an enlarged working end of the muddler when inserted therethrough.

8. The muddler aid device of claim 1 wherein the muddler access port, the plurality of discharge apertures and the grip feature are symmetric about a same plane of symmetry.

9. The muddler aid device of claim 1, further comprising:
a channel defined on an underside of the body to route muddled contents toward the plurality of discharge apertures when discharging contents from the open-ended receptacle.

10. The muddler aid device of claim 1, further comprising:
a barrier defined on an underside of the body around at least a portion of the muddler access port.

11. The muddler aid device of claim 1 wherein the grip feature is centrally located and defines a concave surface to receive a finger of a user when discharging contents from the open-ended receptacle.

12. The muddler aid device of claim 1, further comprising:
an integrally formed spout at an edge of the muddler aid device proximate the plurality of discharge apertures to assist in discharging muddled contents.

13. The muddler aid device of claim 1 wherein the sidewall is sized to loosely engage the mouth of the receptacle.

14. The muddler aid device of claim 1 wherein the sidewall is sized to sealingly engage the mouth of the receptacle.

15. The muddler aid device of claim 1, further comprising:
a cover coupled to the body to selectively cover the plurality of discharge apertures.

16. The muddler aid device of claim 1, further comprising:
a cover coupled to the body to selectively cover the muddler access port.

17. The muddler aid device of claim 16 wherein the cover is movably coupled to the body to selectively cover the muddler access port and the plurality of discharge apertures alternatively.

18. A muddler system comprising the muddler aid of claim 1 and a muddler.

19. The muddler system of claim 18, further comprising:
an open-ended receptacle, and wherein the muddler aid, the muddler and the open-ended receptacle are packaged together.

20. A method of muddling, comprising:
positioning a muddler aid device over an open-ended receptacle, the muddler aid device including a body in the form of a generally planar disc to cover at least a majority of a mouth of the open-ended receptacle, a muddler access port, a plurality of discharge apertures and a grip feature;
muddling contents of the open-ended receptacle with a muddler received through the muddler access port; and
straining the muddled contents through the plurality of discharge apertures while engaging the grip feature.
